(19) United States
(12) Patent Application Publication
(10) Pub. No.: US 2013/0229617 A1
(43) Pub. Date: Sep. 5, 2013

(54) VARIABLE FOCUS SPECTACLES WITH BIPOLAR LENS UNITS AND FRONT MASKING LENSES

(71) Applicant: ZOOM FOCUS EYEWEAR LLC DBA SUPERFOCUS LLC, (US)

(72) Inventor: Stephen Kurtin, Sherman Oaks, CA (US)

(73) Assignee: ZOOM FOCUS EYEWEAR LLC DBA SUPERFOCUS LLC, Van Nuys, CA (US)

(21) Appl. No.: 13/783,833

(22) Filed: Mar. 4, 2013

Related U.S. Application Data
(60) Provisional application No. 61/606,411, filed on Mar. 4, 2012.

(51) Int. Cl. G02C 7/08

(52) U.S. Cl. CPC G02C 7/085
USPC 351/159.41

(57) ABSTRACT

Variable focus spectacles including bipolar variable focus lens units and a front masking lens disposed in front of each variable focus lens unit. Each bipolar variable focus lens unit has a transparent rigid member, a transparent distensible membrane, a membrane support on which the membrane is mounted, a transparent liquid of a fixed volume filling in a sealed space between the rigid member and the membrane, and is connected to a bidirectional actuating mechanism for urging the membrane support and the rigid member to move toward and away from each other. Each front masking lens may have any suitable shape so long as its front surface is convex and reflections off that front surface typically dominate reflections off the underlying distensible membrane.

### BACKGROUND OF THE INVENTION

1. Field of the Invention

This invention relates to variable focus spectacles, and in particular to variable focus spectacles having bipolar variable focus lens units.

2. Description of the Related Art

Variable focus spectacles are spectacles which provide adjustable optical power (i.e., adjustable focal length). For example, U.S. Pat. Nos. 5,138,494, 5,371,629 and 5,668,620 describe variable focal length lenses for use in spectacles. These lenses include a rigid rear optical surface to provide the wearer's distance correction, and a liquid-backed distensible elastomeric membrane to provide an adjustable optical addition. The liquid, which has a fixed volume, is stored in the field of view and between a) the elastomeric membrane and b) the front surface of the rigid lens which provides the rear rigid optical surface of the variable focus lens. Adjustment of the optical power of the liquid filled lens is achieved by displacement, or pivoting, of the outer periphery of the distensible membrane or its support. In U.S. Pat. No. 5,668,620, as the optical power is adjusted the membrane can be distended to become either concave, or flat, or convex. A variable focus lens with this property is said to be “bipolar”.

U.S. Pat. No. 7,866,816 describes variable focus spectacles which comprise i) a focus module that includes two variable focus lenses, and ii) two fixed plastic lenses that preferably includes most or all of the optical power needed by the intended wearer to correct his/her distance vision. The fixed plastic lenses are preferably attached to the focus module by magnetic attraction.

### SUMMARY OF THE INVENTION

The present invention is directed to variable focus spectacles that substantially obviate limitations and disadvantages of the related art.

An object of the present invention is to provide variable focus spectacles that use bipolar variable focus lens units without otherwise inherent adverse effects on esthetics.

Additional features and advantages of the invention are set forth in the descriptions that follow and in part will be apparent from those descriptions, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides variable focus spectacles, which include: a variable focus lens unit including a transparent rigid member, a transparent distensible membrane, a membrane support on which the membrane is mounted, a transparent liquid of a fixed volume filling a sealed space between the rigid member and the membrane; a bidirectional actuating mechanism for urging the membrane support and the rigid member to move (including via pivoting) toward and away from each other, wherein the transparent distensible membrane is distended forward or backward and its front surface becomes concave, flat, or convex as the membrane support and the rigid member move toward or away from each other; and a front masking lens having a convex front surface and disposed in front of the variable focus lens unit.

In another aspect, the present invention provides variable focus spectacles which include: a variable focus lens unit, which includes a transparent distensible membrane and a transparent liquid filling a space defined by the variable focus lens unit behind the membrane; a bidirectional actuating mechanism for applying a pressure on the liquid to cause the membrane to be distended forward or backward and its front surface to become concave, or flat, or convex; and a front lens having a convex front surface and disposed in front of the variable focus lens unit.

In one implementation, the front surface of the front lens has a reflectivity that is at least one-fifth of a reflectivity of the front surface of the membrane.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B are side cross sectional views showing a prior art bipolar variable focus lens (also, herein, called a bipolar variable focus “lens unit”).

FIG. 2 is a side view showing a bipolar variable focus lens unit together with a front masking lens according to an embodiment of the present invention.

FIG. 3 is a side view showing a bipolar variable focus lens unit together with a front masking lens according to another embodiment of the present invention.

FIG. 4 is a side view showing a bipolar variable focus lens unit together with a front masking lens according to yet another embodiment of the present invention.

FIG. 5A and 5B illustrate a prior art bidirectional actuating mechanism for spectacles using the bipolar variable focus lens, which can be used to implement embodiments of the present invention.

### DETAILED DESCRIPTION OF THE PREFERRED EMBODIMENTS

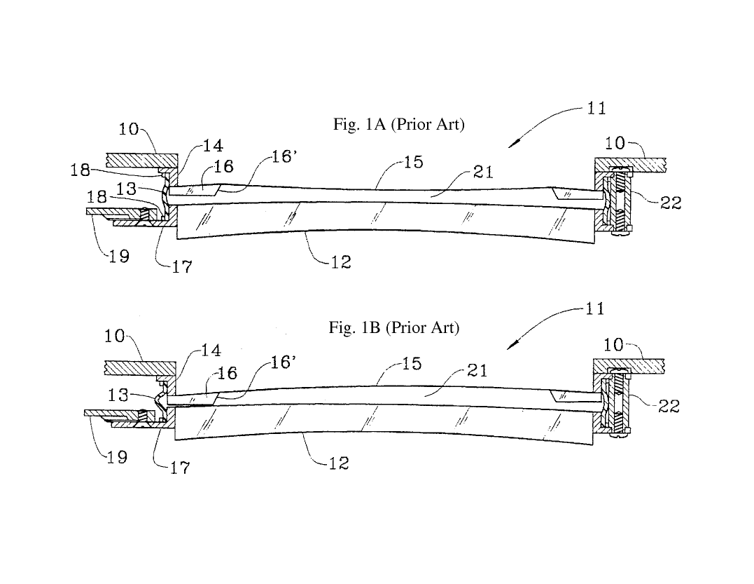

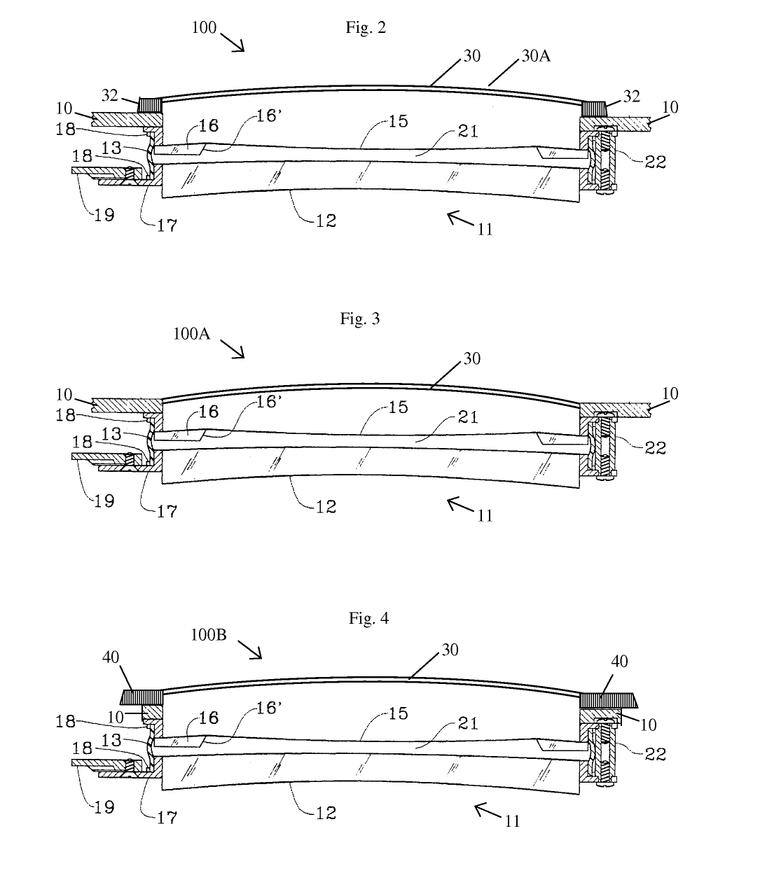

FIGS. 2 and 3 of U.S. Pat. No. 5,668,620 (“the '620 patent”, which is herein incorporated by reference in its entirety) are reproduced as FIGS. 1A and 1B of this disclosure. These figures are horizontal cross sectional views of a variable focus lens unit, each taken with the lens unit oriented vertically (which is to say, with the lens unit oriented as typically worn). As shown in these figures, a variable focus lens unit 11 (referred to as the lens assembly in the '620 patent) includes a rigid lens 12, a distensible membrane 15, and a fixed volume of a transparent liquid 21 filling the sealed space in between. The membrane 15 is mounted on a membrane support 16; an actuating mechanism operates to change the relative position of the membrane support 16 with respect to the rigid lens 12, such that they move toward or away from each other. In the present disclosure, the term “move” encompasses pivoting movement as well as linear translation and combinations of both. As a result of such movements, and the fixed volume of liquid 21 present between the rigid lens 12 and the membrane 15, the membrane 15 is distended outwardly or inwardly (i.e., forward or backward), taking a convex or concave shape as respectively shown in FIGS. 1B and 1A. If the index of refraction of the liquid matches, or nearly matches, the index of refraction of the rigid lens, then the shape of the rear surface of rigid lens 12, together with the shape of the membrane 15, determines the optical power of the lens unit 11. (If the rigid lens 12 and the liquid 21 do not have identical, or nearly identical, refractive indices, then their interface becomes a third optically significant surface.) The adjustment range of the optical power of the lens unit 11 is determined by the adjustment range of the shape of the membrane 15.

FIGS. 1A and 1B also illustrates other structural components of the spectacles, including a front ring 14 of the lens assembly which is attached to frame 10 and on which the membrane support 16 is mounted; an opening 16′ of the membrane support 16 which defines the free area of membrane 15; a rear ring 17 to which the rigid lens 12 is attached; a flexible seal 13, made of fluorosilicone rubber or other suitable materials, which is sealed to the rear ring 17 and front ring 14; compression rings 18 which hold the seal 13 in place; a flex hinge 22 which connects a first point of the rear ring 17 to the frame 10, such that the rear ring 17 is a spaced apart from the frame and can pivot with respect to the frame at the first point; and an adjusting tab 19 which is attached to the rear ring 17 at a second point remote from the hinge 22 and extends outward from the second point. The variable focus spectacles include two variable focus lens units 11 connected by a bridge (not shown). These structures are parts of the embodiments of the '620 patent, and provides one example of implementation relevant to the present invention; however, the present invention is not limited to the specifics of the embodiments of the '620 patent shown in FIGS. 1A and 1B here.

In the orientation depicted in FIGS. 1A and 1B, the wearer's eye is located below the rigid lens 12 and the front of the spectacles is above the membrane 15. When the membrane 15 is convex, it is distended toward the front; and when it is concave, it is distended toward the rear. In this disclosure, “front” means the side farther away from the wearer and “rear” means the side closer to the wearer. “Forward” means away from the wearer and “backward” means toward the wearer.

As recognized in the '620 patent, a bipolar lens unit—i.e., one in which the distensible membrane can be caused to distend from concave, to flat, to convex—has certain advantages. In particular, the range of optical power adjustment is the difference in optical power when the membrane is at its maximum convexity vs. maximum concavity. In contrast, for a unipolar lens unit—i.e., one in which the distensible membrane can be distended only into a convex shape, or only into a concave shape—the range of optical power adjustment is the optical power when the membrane is at its maximum convexity (or concavity) less the optical power when the membrane is at its minimum convexity (or concavity). For a unipolar lens unit and a bipolar lens unit to have the same range of optical power adjustment, the maximum convexity (or concavity) of the bipolar lens unit will be significantly less than the maximum convexity (or concavity) of the unipolar liquid lens. Because the forces developed by the membrane—and hence which must be controlled by the actuating mechanism—are typically non-linearly related to the degree of convexity or concavity of the membrane, the actuating mechanism in the bipolar lens unit will typically experience significantly smaller maximum forces.

While it has certain advantages as discussed above, a problem with the bipolar lens unit 11 shown in FIGS. 1A and 1B is that a when it is adjusted such that the membrane assumes a concave shape (as shown in FIG. 1A) or a flat shape, that concave or flat shape is readily visible to an observer located in front of, or to the side of, the user. This is generally considered aesthetically unappealing, or even unacceptable.

To solve this problem, variable focus spectacles according to embodiments of the present invention provide a front masking lens for each lens unit, as illustrated in FIG. 2. The lens unit 100 (one of the two lens units of the spectacles) includes a variable focus lens unit 11, and a front masking lens 30 attached to the front of the variable focus lens unit 11. For convenience of illustration, the variable focus lens unit 11 shown in FIG. 2 is identical to the lens unit 11 shown in FIGS. 1A and 1B, but any other suitable structures may be used. The front masking lens 30 may have a positive, negative, or zero optical power (the example shown in FIG. 2 is a meniscus lens with zero optical power), but its front surface 30A is always convex. Preferably, the rear surface of the front masking lens (the surface facing the membrane) is concave. The optical power of the lens unit 100 is the combined optical power of the lens unit 11 and the front masking lens 30. Preferably this combination is designed such that the optical power of lens unit 100 at maximum concavity of the membrane 15 is the optical power needed to correct the distant vision of the wearer.

In addition to possibly providing optical power, the front masking lens 30 functions to mask the concave surface of the membrane 15, i.e., it makes the flat or concave surface of the membrane 15 substantially unnoticeable to observers. To put it another way, the front masking lens 30 is designed such that the reflections from the front masking lens dominate the reflections from the flat or concave membrane 15. Optically, this requires the light directly reflected by the front surface of the front masking lens 30 to be substantially more visible than the light that is transmitted through the front masking lens, reflected by the membrane surface, and then transmitted back through the front masking lens. To accomplish this result, in one implementation the reflectivity of the front surface of the front masking lens 30 has at least one-fifth the reflectivity of the front surface of the membrane 15. Generally speaking, the higher the reflectivity of the front surface of the front masking lens 30, the better the masking. In practice, for example, if the front masking lens 30 is free of any anti-reflection (AR) coating, it will adequately achieve the masking function (whether or not the membrane 15 is coated with an AR coating).

It is noted that when an ophthalmic lens is used conventionally, high front surface reflectivity is not generally considered to be a positive attribute. The design of a front masking lens—e.g. the choice of the most appropriate material, front surface curvature and anti-reflection coating—becomes, therefore, a trade-off between two goals: i) masking, and ii) front surface reflectivity per se. It has also been found, for example, that a front masking lens the front surface of which has convex curvature which is greater than the maximum convex curvature of the membrane 15 tends to mask more effectively than a front masking lens having lesser front surface curvature. Accordingly the choice of front surface curvature can be guided by this consideration, with (once a target optical power is chosen) relevance for the choice of front lens material. Although specific guidance—for example as to reflectivity values and ranges—is given above, those skilled in the art will recognize that, through routine experimentation, other suitable values or ranges may be learned and can be used to implement embodiments of the present invention. The invention broadly covers all such suitable reflective properties that serve the masking function.

The front masking lens 30 may be attached to the variable focus lens unit 11 by any suitable means, including fixed or removable latching. For example, as shown in FIG. 2, the front masking lens 30 may include a ring 32 which includes magnets for magnetically and removably attaching to a frame 10 of the variable focus lens unit 11. Another example of attaching a front lens to a frame of variable focus spectacle using magnets is shown in U.S. Pat. No. 7,866,816, which is herein incorporated by reference in its entirety.

FIG. 3 shows an example of a lens unit 100A where the front masking lens 30 is directly and permanently attached to the frame 10 of the variable focus lens unit 11. The space between the front masking lens 30 and the membrane 15 is not air-tight, so that the air in this space exerts only atmospheric pressure on the membrane 15. For example, ventilation holes may be provided in the peripheral area of the front masking lens 30, or intermittent gaps may be provided along the connection line between the frame 10 and the front masking lens 30. The other components of the lens unit 100A are identical to those of the lens unit 100.

FIG. 4 shows an example of another lens unit 100B where the front masking lens 30 is an integral part of a frame structure 40 of a pair of spectacles. The frame structure includes two lens frames (partly shown as item 40 in FIG. 4) on which the front masking lens 30 is permanently mounted, a bridge between the lens frames, and two temples connected to the lens frames via hinges (not shown in FIG. 4). The variable lens unit 11 is attached to the frame structure 40 on the rear side of that structure. For example, the frame 10 of the lens unit 11 may be attached to the frame structure 40 by magnets or other suitable attachment means.

The variable focus spectacles include two variable focus lens units 100/100A/100B located on two sides of the bridge.

It should be emphasized again that although considerable details of the variable focus lens unit 11 are shown in FIGS. 2-4, the present invention is not limited to any particular structure of the variable focus lens unit 11. Any suitable structure of a bipolar variable focus lens unit may be used to implement embodiments of this invention.

Stated more generally, a lens unit for variable focus spectacles according to embodiments of the present invention includes a bipolar variable focus lens unit which has a membrane that can be distended in both directions (convex and concave), and a front masking lens attached in front of the variable focus lens unit. The bipolar variable focus lens unit may have any suitable structure; the front masking lens may have any suitable shape so long as its front surface is convex.

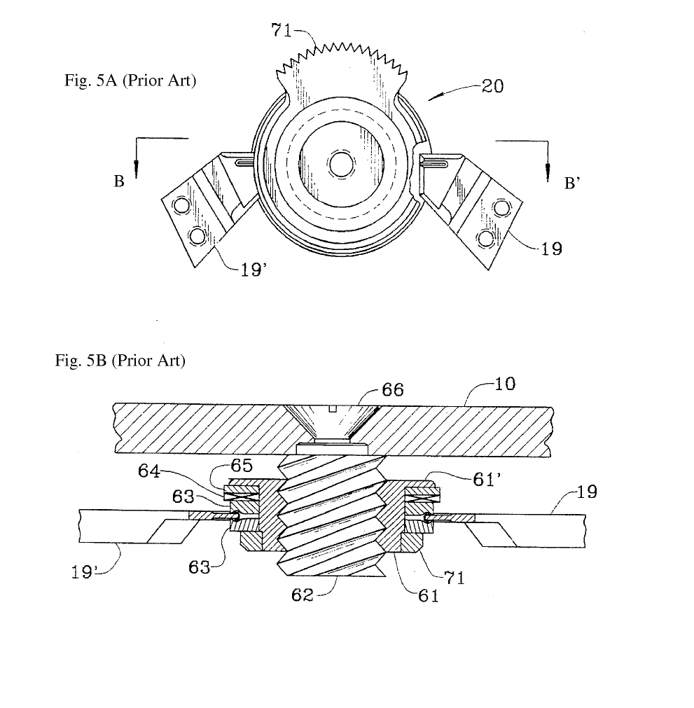

In embodiments of the present invention, the bipolar variable focus lens unit is provided with an actuating mechanism to adjust its optical power. Because the membrane of the liquid lens is to be distended both convexly and concavely during optical power adjustment, the actuating mechanism is required to have the ability to urge the membrane support and the rigid lens to move, relative to each other, together and apart. Such an actuating mechanism may be referred to as a bidirectional actuating mechanism. In one embodiment of the present invention, a bidirectional actuating mechanism as described in the '620 patent is used. FIGS. 7 and 8 of the '620 patent are adapted as FIGS. 5A and 5B of this disclosure. FIG. 5A is a rear view of the bidirectional actuating mechanism (actuator) 20, i.e., viewed from the direction of view of the wearer of the spectacle. The actuator 20 is located in the bridge of the spectacles which connects two variable focus lens units 100/100A. FIG. 5B is a cross sectional view of the actuating mechanism 20 in the direction of arrows B-B′ of FIG. 5A. The description below is adapted from the '620 patent.

As shown in FIGS. 5A and 5B, linear motion which is imparted to adjusting tabs 19 and 19′ by the actuator 20 is created by rotating nut 61 around threaded stud 62. Knurled finger-wheel 71, which is the element engaged by the wearer to adjust the focal length, is pressed onto nut 61. Two washers 63, a wave spring 64, and a shim 65 are located in the space between the finger wheel 71 and flange 61′ of nut 61. The washers 63 engage adjusting tabs 19 and 19′. As nut 61 is rotated by the wearer's finger pressure on finger wheel 71, the washers remain rotationally stationary, but move axially with respect to threaded stud 62. The linear axial motion is coupled to the adjusting tabs 19 and 19′, and the focal length of each lens is thereby changed. The threaded stud 62 is held to frame 10 by screw 66. The angular position of stud 62 may be set on assembly to the position which locates adjusting tabs 19 and 19′ as desired with respect to the angular position of finger wheel 71.

The actuator as described above is capable of exerting actuation forces in either direction, and hence is suitable for use with a variable focus lens unit wherein the membrane shape changes from concave to convex within its range of operation.

In other embodiments, a modified actuating mechanism based on any one of the actuating mechanisms described in U.S. Pat. No. 6,053,610 (“the '610 patent”), U.S. Pat. No. 7,008,054 (“the '854 patent”) or U.S. Pat. Appl. No. 61/584,269 (“the '269 application”, filed Jan. 8, 2012) may be used. These patents and patent application are herein incorporated by reference in their entireties.

Each of the '610 and '054 patents and the '269 application describes a unipolar adjustable focus lens unit, and a unidirectional actuating mechanism which can only exert a force to urge i) the rigid lens (or an equivalent component) and ii) the membrane support to move toward each other, thereby causing the membrane to distend outwardly. When the membrane is distended outwardly, the consequent tension in the membrane—acting via the liquid enclosed under the membrane—tends to urge the rigid lens and the membrane support to move away from each other. This tendency, which may be referred to as the restoring force, exists until the membrane is flat. Thus, from a state where the membrane is distended outwardly, if the urging force of the actuating mechanisms is relaxed, the restoring force will cause the rigid lens and the membrane support to move away from each other. When the membrane is flat, the actuating mechanism described in the above patents and patent application lacks the ability to cause the rigid lens and the membrane support to move further away from each other, and therefore lacks the ability to cause the membrane to become concave.

To achieve bidirectional actuation, the actuation mechanisms described in the '610 or '054 patents or the '269 application is modified by additionally providing a biasing member which urges the rigid lens and the membrane support to move away from each other. The biasing force is present even when the membrane is already concave. Such a biasing member may be fixedly mounted on the frame of the spectacle and be non-adjustable. The biasing member may be implemented by a spring or other resilient members. In operation, the force exerted by the existing actuating mechanism overcomes the biasing force to cause the rigid lens and the membrane support to move toward each other, causing the membrane to distend outwardly (i.e. become convex). When the membrane is convex and the force exerted by the existing actuating mechanism is relaxed, the force of the biasing member and the restoring force of the liquid cause the rigid lens and the membrane support to move away from each other. When the membrane is flat and the force exerted by the existing actuating mechanism continues to be relaxed, the force of the biasing member overcomes the restoring force arising from tension in the membrane to cause the rigid lens and the membrane support to continue to move away from each other. As a result, the membrane becomes concave.

The optical power of the rigid lens and/or front masking lens can be designed based on a user's refractive prescription. For example: assume that the user's prescription for far vision is −4.00 D, and that the optical power adjustment range of the adjustable focus lens unit is −1.50 D to +1.50 D. In this case the optical power of the front masking lens should be −2.50 D, giving the lens unit a combined optical power of −4.00 D to −1.00 D, suitable for the above user.

It will be apparent to those skilled in the art that various modification and variations can be made in the apparatus and method of the present invention without departing from the spirit or scope of the invention. Thus, it is intended that the present invention cover modifications and variations that come within the scope of the appended claims and their equivalents.

What is claimed is:

1. Variable focus spectacles, comprising:
a variable focus lens unit, which includes:
a transparent rigid member;
a transparent distensible membrane;
a membrane support on which the transparent distensible membrane is mounted; and
a transparent liquid of a fixed volume filling a sealed space between the rigid member and the membrane;
a bidirectional actuating mechanism for urging the membrane support and the rigid member to move toward and away from each other, wherein the transparent distensible membrane is distended forward or backward and its front surface becomes concave, or flat, or convex as the membrane support and the rigid member move toward, or away, from each other; and
a front lens having a convex front surface and disposed in front of the variable focus lens unit.

2. The variable focus spectacles of claim 1, wherein the front surface of the front lens has a reflectivity that is at least one-fifth of a reflectivity of the front surface of the membrane.

3. The variable focus spectacles of claim 1, wherein the variable focus lens unit includes a frame on which the membrane support is mounted, and wherein the front lens includes a ring which has magnets for magnetically and removably attaching the front lens to the frame.

4. The variable focus spectacles of claim 1, wherein the variable focus lens unit includes a frame on which the membrane support is mounted, and wherein the front lens is permanently attached to the frame.

5. The variable focus spectacles of claim 1, further comprising a frame structure, wherein the front lens is permanently mounted on the frame structure, wherein the variable focus lens unit includes a frame on which the membrane support is mounted, and wherein the frame of the variable focus lens unit is attached to the frame structure.

6. The variable focus spectacles of claim 1, wherein the front lens has a positive optical power.

7. The variable focus spectacles of claim 1, wherein the front lens has a negative optical power.

8. The variable focus spectacles of claim 1, wherein the front lens has zero optical power.

9. The variable focus spectacles of claim 1, wherein the front lens has a concave rear surface.

10. Variable focus spectacles, comprising:
a variable focus lens unit, which includes a transparent distensible membrane and a transparent liquid filling a space defined by the variable focus lens unit behind the membrane;
a bidirectional actuating mechanism for applying a pressure on the liquid to cause the membrane to be distended forward or backward and its front surface to become concave, or flat, or convex; and
a front lens having a convex front surface and disposed in front of the variable focus lens unit.

11. The variable focus spectacles of claim 10, wherein the front surface of the front lens has a reflectivity that is at least one-fifth of a reflectivity of the front surface of the membrane.

12. The variable focus spectacles of claim 10, wherein the front lens has a positive optical power.

13. The variable focus spectacles of claim 10, wherein the front lens has a negative optical power.

14. The variable focus spectacles of claim 10, wherein the front lens has zero optical power.

15. The variable focus spectacles of claim 10, wherein the front lens has a concave rear surface.
